(19) United States
(12) Patent Application Publication
(10) Pub. No.: US 2007/0220174 A1
(43) Pub. Date: Sep. 20, 2007

(54) Marker placement in a mapping environment

(75) Inventor: Raj Vasant Abhyanker, Cupertino, CA (US)

Correspondence Address: Raj Abhyanker, LLP;c/o Intellevate, P.O. Box 52050, Minneapolis, MN, 55402, US

(73) Assignee: Fatdoor, Inc.

(21) Appl. No.: 11/714,324

(22) Filed: Mar. 5, 2007

Related U.S. Application Data
(60) Provisional application No. 60/783,226, filed on Mar. 17, 2006.
(60) Provisional application No. 60/817,470, filed on Jun. 28, 2006.
(60) Provisional application No. 60/853,499, filed on Oct. 19, 2006.
(60) Provisional application No. 60/854,230, filed on Oct. 25, 2006.

(51) Int. Cl. G06F 15/16

(52) U.S. Cl. 709/250

(57) ABSTRACT

A method, apparatus, and system of marker placement in a mapping environment are disclosed. In one embodiment, a method includes generating a marker in a mapping environment using an algorithm based on an address data, placing the marker in the mapping environment adjacent to a physical location identified through the address data using the algorithm and automatically relocating the marker in the mapping environment to the physical location identified through the address data responsive to a user-provided marker movement. The method may also include generating a wiki marker movement request that identifies markers no claimed by any user in the mapping environment as candidates of relocation, processing a marker locking request when a wiki profile associated with the address data is claimed by a particular user and enabling the particular user to control future relocations of the marker when the user claims the wiki profile associated with the address data.

### CLAIMS OF PRIORITY

This patent application claims priority from:

### (1) U.S. Provisional patent application No. 60/783,226, titled ‘Trade identity licensing in a professional services environment with conflict’ filed on Mar. 17, 2006.

### (2) U.S. Provisional patent application No. 60/817,470 titled ‘Segmented services having a global structure of networked independent entities’, filed Jun. 28, 2006.

### (3) U.S. Provisional patent application No. 60/853,499, titled ‘Method and apparatus of a neighborhood expression and end user contribution system’ filed on Oct. 18, 2006.

### (4) U.S. Provisional patent application No. 60/854,230 titled ‘Method and apparatus of neighborhood expression and end user contribution system’ filed on Oct. 25, 2006.

(5) U.S. Utility patent application Ser. No. 11/603,442 titled ‘Map based neighborhood search and community contribution’ filed on Nov. 22, 2006.

### FIELD OF TECHNOLOGY

This disclosure relates generally to the technical fields of communications and, in one example embodiment, to a method, apparatus, and system of marker placement in a mapping environment.

### BACKGROUND

A marker (e.g., a pushpin, an indicator, a pointer, a pin, etc.) may indicate (e.g., point to, highlight, etc.) a location (e.g., a place, a person, etc.) in a mapping environment (e.g., Microsoft® Virtual Earth, Google® Earth, Yahoo® Maps, Mapquest.com®, Fatdoor.com®, etc.). The location of the marker may be determined using an algorithm (e.g., a block interpolation algorithm) which places the marker in the mapping environment based on a latitude/longitude data associated with a physical location (e.g., a particular street). For example, the location of the marker may be determined using a mathematical method of determining the location by using average values of nearby markers on either side of one to be created.

The mapping environment may include aerial photography over neighborhoods and/or places in a terrestrial environment (e.g., the Earth). The aerial photography may show rooftops and/or physical buildings in perspective view (e.g., three dimensional images), in which people can visually identify their own properties (e.g., homes) and/or properties of people/places they know (e.g., friends, family, neighbors, places of interest, etc.). However, the algorithm may place markers nearby, but not precisely on, a correct rooftop, landmark and/or physical building in perspective view. As a result, driving directions between users (e.g., friends, businesses, landmarks) in the mapping environment may not be accurate. Furthermore, users may be disappointed when seeing the marker inaccurately placed in the mapping environment.

### SUMMARY

A method, apparatus and system of marker placement in a mapping environment are disclosed. In one aspect, a method includes generating a marker in a mapping environment using an algorithm based on an address data, placing the marker in the mapping environment adjacent to a physical location identified through the address data using the algorithm and automatically relocating the marker in the mapping environment to the physical location identified through the address data responsive to a user-provided marker movement.

The method may include generating a wiki marker movement request that identifies markers not claimed by any user in the mapping environment as candidates of relocation. Furthermore the method may include processing a marker locking request when a wiki profile associated with the address data is claimed by a particular user and enabling the particular user to control future relocations of the marker when the user claims the wiki profile associated with the address data.

In addition, the method may include transforming a state of the mapping environment to a marker edit state when the relocating the marker in the mapping environment event occurs. Also, the method may include logging a history of marker relocations in the mapping environment. The method may further include simultaneously moving multiple ones of the marker when the marker edit state is transformed to a marker fixed state based on a cached request of concurrent marker movements.

Moreover, the method may include providing adjacent properties in the neighborhood as candidates in the cached request of concurrent marker movements when the marker edit state is transformed to the marker fixed state. The method may also include bulk relocating multiple ones of the adjacent properties in neighborhood responsive to a lassoing of multiple adjacent properties in the mapping environment. The method may include applying a block interpolation technique in the algorithm to generate the marker and/or to place the marker in the mapping environment adjacent to the physical location identified through the address data. Furthermore, the method may include applying a dimensional perspective in the mapping environment while retaining a placement of a relocated marker and/or other markers in the mapping environment.

In addition, the method may include correcting an accuracy of the placement of the relocated marker in a particular view using a polygonal resolution algorithm through a rendering of an approximate polygonal shape that matches a distorted perspective in any view desired with the relocated marker through a vector and color matching methodology. The method may also include refreshing a mapping data which comprises the mapping environment while retaining the accuracy of placement of the relocated marker in a geo-spatial environment through the polygonal resolution algorithm and an error correction algorithm that compares refreshed map data with previous state map data to render geo-spatial distance coordination between marker points using a latitudinal data and a longitudinal data.

Furthermore, the method may include applying a drag and drop algorithm that enables the user to sequentially and/or concurrently relocate markers in the mapping environment, iteratively performing additional verifications when any particular marker has been previously moved when the previous movement was made after the generation and placement of the marker using the algorithm and when the previous marker movement is associated with a polygon that is determined to approximately center on a rooftop rather than a street based on a polygonal identification of sides of the rooftop being substantially more square than that of the street and generating accurate driving directions and/or distance estimations between any starting point and the relocated marker using a modified latitude and longitude data associated with the relocated marker when a directions algorithm is applied.

In addition, the method may include processing a latitude and longitude data provided by a mobile device presently at a physical address associated with the address data to more accurately and automatically move the marker atop the physical location. The method may also include syndicating a user updated marker data to other mapping providers across the web so that other providers can build applications and/or tools using higher accuracy rooftop location data provided through the automatic relocating of the marker and/or other markers responsive to the user provided marker movement.

The method may further include generating a cascaded marker indicator when there are multiple user profiles at the physical location identified through the address data and placing multiple markers in a floor of the physical location through the user provided marker movement when the cascade marker indicator is enabled.

In another aspect, a system includes a mapping module to render a geo-spatial environment concurrently representing neighboring places and/or profiles using a set of markers, and a relocation module to enable users of the geo-spatial environment to simultaneously move any one or more of the set of markers until the neighboring places and/or profiles are claimed by a claimant so that more accurate location markers are enabled through a user-generated wiki edit of markers identified in the geo-spatial environment.

Furthermore, the system may include a floor plan module to create tiered physical spaces in a building representing a subset of the neighboring places and/or profiles based on a physical separation between grouped profiles in any one of a vertical, horizontal, and/or logical form such that the floor plan module segments and separates certain profiles in the geo-spatial environment from others and such that the floor plan module provides a context in which relocation of markers occurs in a fixed grouping of geo-spatially distributed floors.

Also, the system may include a rectification module to maintain any relocated marker in perspective view as accurately placed based on a polygon and color matching algorithm that considers an effect of a distortion of a polygon underlying a marker when viewed in any particular perspective desired in the geo-spatial environment. In addition, the system may include a lasso module to enable selection of multiple markers simultaneously and group-move the lassoed markers simultaneously to a desired location.

Moreover, the system may include a locking module to sequentially make more difficult subsequent movements of the relocated marker as a function of time, space, and/or verification of location by other users in the geo-spatial environment when the other users chose to not move the relocated marker but do choose to move neighboring markers to the relocated marker in previous relocation events.

In yet another aspect, a method includes capturing, in a map, a graphical representation of locations physically present in a neighborhood through a set of pushpins each indicating a profile associated with an address, physically relocating any one or more of the set of pushpins when a user drags and drops them to a desired location visible in the graphical representation and securing (e.g., securing at least some pushpins may be determined based on a claiming of a wiki-profile associated with the at least some pushpins by the user) at least some pushpins in the map from movement by the user.

In addition, the method may include creating a distinctive pushpin that represents multiple profiles when there are multiple profiles associated with the same address. The method may further include organizing some of profiles associated with the distinctive pushpin based on level when the user drags and drops certain of the profiles as being associated with a segmented portion of a building represented by the distinctive pushpin.

Moreover, the method may include forming a social network overlaying the map in which claimed ones of the wiki-profiles are marked private and/or public and in which members of the social network are able to relocate pushpins that are not claimed in addition to relocating their own claimed profile pushpins and in which users can self identify content that is made publicly available in a public profile and/or self identify content which is privately visible only to friends, neighbors and/or families, and in which users can arrange pushpins associated with homes, businesses, and/or landmarks a threshold distance away surrounding their primary claimed profile pushpin.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a mapping environment communicating with a neighborhood through a network, according to one embodiment.

FIG. 2 is an exploded view of the relocation module of FIG. 1, according to one embodiment.

FIG. 3 is an exploded view of the lasso module of FIG. 1, according to one embodiment.

FIG. 4A is a map view showing placement of a marker in the mapping environment, according to one embodiment.

FIG. 4B is a map view showing placement of multiple markers in the mapping environment, according to one embodiment.

FIG. 5 is a user interface view of locating markers in the mapping environment, according to one embodiment.

FIG. 6 is a diagrammatic system view of a data processing system in which any of the embodiments disclosed herein may be performed, according to one embodiment.

FIG. 7 is a perspective view of markers arranged in the geospatial environment, according to one embodiment.

FIG. 8 is a table view of marker relocation data in the mapping environment, according to one embodiment.

FIG. 9 is a user interface view of the relocation module of FIG. 1, according to one embodiment.

FIG. 10 is a flow chart of a polygonal resolution algorithm, according to one embodiment.

FIG. 11A is a process flow of locating the marker in the mapping environment to a physical location identified through an address data, according to one embodiment.

FIG. 11B is a continuation of the process flow of FIG. 11A showing additional processes, according to one embodiment.

FIG. 11C is a continuation of the process flow of FIG. 11B showing additional processes, according to one embodiment.

FIG. 11D is a continuation of the process flow of FIG. 11C showing additional processes, according to one embodiment.

FIG. 12 is a process flow of locating set of pushpins indicating profiles associated with the address data, according to one embodiment.

Other features of the present embodiments will be apparent from the accompanying drawings and from the detailed description that follows.

### DETAILED DESCRIPTION

A method, apparatus, and system of marker placement in a mapping environment are disclosed. In the following description, for the purposes of explanation, numerous specific details are set forth in order to provide a thorough understanding of the various embodiments. It will be evident, however to one skilled in the art that the various embodiments may be practiced without these specific details.

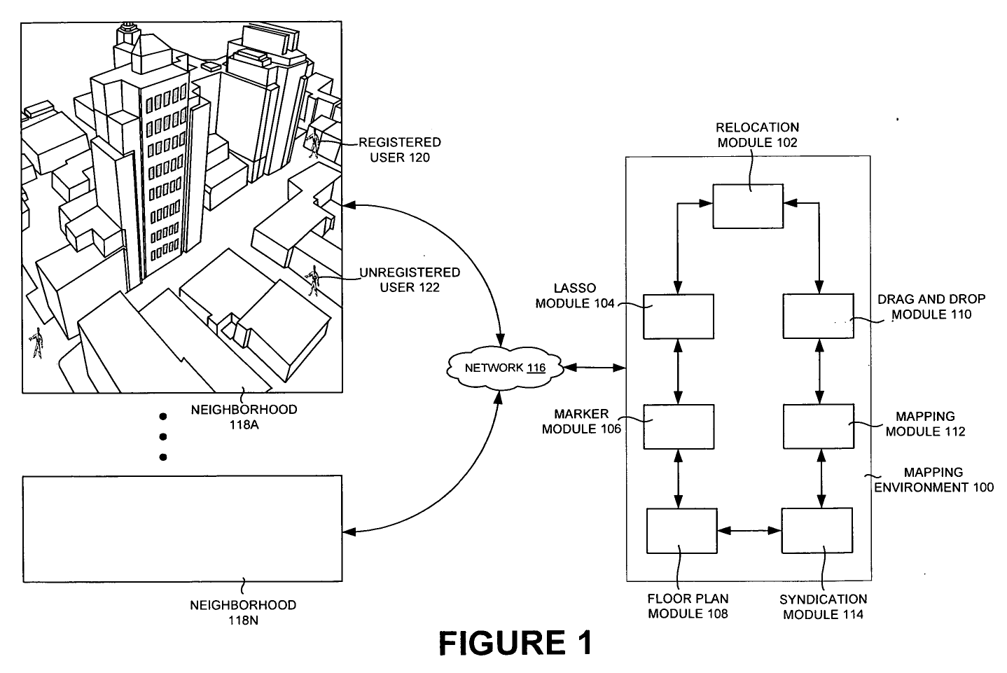

In one embodiment, a method includes generating a marker in a mapping environment (e.g., a mapping environment 100 of FIG. 1) using an algorithm based on an address data, placing the marker (e.g., using a marker module 106 of FIG. 1) in the mapping environment adjacent to a physical location identified through the address data using the algorithm and automatically relocating the marker (e.g., through a relocation module 102 of FIG. 1) in the mapping environment to the physical location identified through the address data responsive to a user-provided marker movement.

In another embodiment, a system includes a mapping module (e.g., a mapping module 112 of FIG. 1) to render a geo-spatial environment concurrently representing neighboring places and/or profiles using a set of markers. In addition, the system includes a relocation module (e.g., a relocation module 102 of FIG. 1) to enable users of the geo-spatial environment to simultaneously move any one or more of the set of markers until the neighboring places and/or profiles are claimed by a claimant so that more accurate location markers are enabled through a user-generated wiki edit of markers identified in the geo-spatial environment.

In yet another embodiment, a method includes capturing, in a map, a graphical representation of locations physically present in a neighborhood (e.g., the neighborhood 118A-N of FIG. 1) through a set of pushpins each indicating a profile associated with an address, physically relocating any one or more of the set of pushpins when a user drags and drops them to a desired location visible in the graphical representation and securing at least some pushpins in the map from movement by the user.

FIG. 1 is a system view of a mapping environment 100 communicating with a neighborhood 118A-N through a network 116, according to one embodiment. Particularly FIG. 1 illustrates a relocation module 102, a lasso module 104, a marker module 106, a floor plan module 108, a drag and drop module 110, a mapping module 112, a syndication module 114, the network 116, the neighborhoods 118A-N, a registered user 120 and an unregistered user 122, according to one embodiment.

The relocation module 102 may enable users (e.g., registered users, unregistered users) in a geo-spatial environment to move (e.g., simultaneously) a set of markers until the neighboring places and/or profiles are claimed by a claimant in order to facilitate accurate location markers through a user-generated wiki edit of markers identified in the geo-spatial environment. The lasso module 104 may enable selection of multiple markers simultaneously and/or may enable a group-move of the lassoed markers concurrently to a desired physical location identified through an address. The lasso module 104 may relocate various adjacent properties in the neighborhood that may be responsive to a lassoing of multiple adjacent properties in the mapping environment.

The marker module 106 may generate the marker in the mapping environment based on an address data and/or may enable the user of the mapping environment to locate the marker (e.g., a pushpin, an indicator, a pointer, etc.) adjacent to a physical location identified through the address data. The marker module 106 may also generate customized indicators based on profile categories (e.g., claimed, unclaimed, locked, etc.) in the mapping environment. The floor plan module 108 may distinguish certain profiles in the geo-spatial environment from others through creating tiered physical spaces in a building based on a physical separation (e.g., vertical, horizontal and/or logical form) between grouped profiles. The floor plan module 108 may also provide a context in which relocation of markers may occur in a fixed grouping of geo-spatially distributed floors. The drag and drop module 110 may enable the user(s) to sequentially and/or concurrently relocate markers in the mapping environment

The mapping module 112 may represent the neighboring places and/or profile (e.g., claimed, unclaimed) in the neighborhood 118A-N in the geo-spatial environment using the set of markers on the map. The syndication module 114 may syndicate the user updated marker data to other mapping providers across the web to facilitate other providers to build applications and/or tools with higher accuracy (e.g., rooftop) location data provided through the automatic relocating of the marker and/or other markers responsive to the user provided marker movement.

The network 116 may enable an efficient communication between the mapping environment 100 and the neighborhood 118A-N. The neighborhood 118A-N may be a geographically localized community located within a larger city, town and/or suburb, associated with the mapping environment. The registered user 120 may be a user of the mapping environment who has claimed the profile associated with the physical location. The unregistered user 122 may be a user who has not claimed the profile and whose wiki profile may be created by other users.

For example, as illustrated in FIG. 1, the mapping environment 100 may contain the relocation module 102, the lasso module 104, the marker module 106, the floor plan module 108, the drag and drop module 110, the map module 112, and the syndication module 114 (e.g., the modules may be interconnected). The mapping environment 100 may communicate with the neighborhood 118 through the network 116 as illustrated in FIG. 1. The registered user 120 and/or the unregistered user 122 may communicate with the neighborhood in the mapping environment.

Furthermore, the marker (e.g., a pushpin, a pointer, an indicator, etc.) in the mapping environment 100 may be generated using the algorithm based on the address data (e.g., street, location, etc.). In addition, the marker in the mapping environment 100 may be placed adjacent to the physical location (e.g., a person's house, a grocery store, a church, etc.) identified through the address data using the algorithm. Also, the marker in the mapping environment 100 may be automatically relocated to the physical location identified through the address data responsive to the user-provided marker movement.

The state of the mapping environment 100 may be transformed to a marker edit state when the relocating the marker in the mapping environment 100 event occurs. In addition, a history of marker relocations may be logged in the mapping environment 100. Moreover, multiple ones of the markers may be moved simultaneously when the marker edit state is transformed to a marker fixed state based on a cached request of concurrent marker movements.

In addition, adjacent properties in the neighborhood 118 may be provided as candidates in the cached request of concurrent marker movements when the marker edit state is transformed to the marker fixed state. Also, multiple ones of the adjacent properties in neighborhood 118 may be bulk relocated, responsive to the lassoing of multiple adjacent properties in the mapping environment 100.

Moreover, a drag and drop algorithm that enables the user to sequentially and/or concurrently relocate markers in the mapping environment 100 may be applied. Further, additional verifications may be iteratively performed when any particular marker has been previously moved when the previous movement was made after the generation and/or placement of the marker, using the algorithm and when the previous marker movement is associated with the polygon that is determined to approximately center on the rooftop rather than the street (e.g., based on a polygonal identification of sides of the rooftop being substantially more square than that of the street).

Furthermore, accurate driving directions and/or distance estimations between any starting point and the relocated marker may be generated (e.g., using a modified latitude and longitude data associated with the relocated marker) when a directions algorithm is applied. Also, a latitude and longitude data provided by the mobile device may be processed presently at the physical address associated with the address data to more accurately and automatically move the marker atop the physical location.

Moreover, the user updated marker data may be syndicated (e.g., through a syndication module 114 of FIG. 1) to other mapping providers across the web so that other providers can build applications and tools using higher accuracy rooftop location data provided through the automatic relocating of the marker and/or other markers responsive to the user provided marker movement. Also, a cascaded marker indicator may be generated when there are multiple user profiles at the physical location identified through the address data (e.g., an apartment building, an office complex). In addition, multiple markers in the floor of the physical location may be placed through the user provided marker movement when the cascade marker indicator is enabled.

The mapping module 112 may render the geo-spatial environment concurrently representing neighboring places and/or profiles using the set of markers. The relocation module 102 may enable users of the geo-spatial environment to simultaneously move any one or more of the set of markers until the neighboring places and/or profiles are claimed by the claimants so that more accurate location markers are enabled through the user-generated wiki edit of markers identified in the geo-spatial environment.

The floor plan module 108 may create tiered physical spaces in the building representing at least a subset of the neighboring places and/or profiles based on the physical separation between grouped profiles in the vertical, horizontal, and/or logical form such that the floor plan module 108 segments and/or separates certain profiles in the geo-spatial environment from others, and/or such that the floor plan module 108 provides the context in which relocation of markers occurs in a fixed grouping of geo-spatially distributed floors. The lasso module 104 may enable selection of multiple markers simultaneously and/or a group-move of the lassoed markers simultaneously to the desired location.

Moreover, a social network overlaying the map may be formed in which claimed ones of the wiki-profiles are marked as private or public and/or in which members of the social network are able to relocate pushpins that are not claimed in addition to relocating their own claimed profile pushpins and/or in which users can self identify content that is made publicly available in a public profile and/or self identify content which is privately visible only to friends, neighbors and/or families, and/or in which users can arrange pushpins associated with homes, businesses, and/or landmarks a threshold distance away, surrounding their primary claimed profile pushpin.

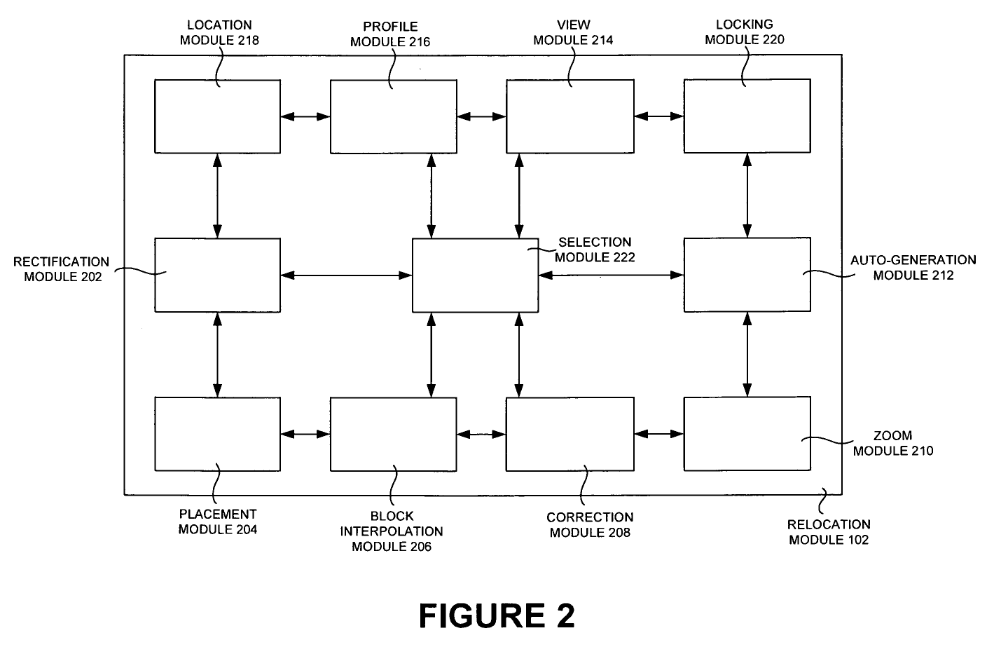

FIG. 2 is an exploded view of the relocation module 102 of FIG. 1, according to one embodiment. Particularly, FIG. 2 illustrates a rectification module 202, a placement module 204, a block interpolation module 206, a correction module 208, a zoom module 210, an auto-generation module 212, a view module 214, a profile module 216, a location module 218, a locking module 220 and a selection module 222, according to one embodiment.

The rectification module 202 may retain the exact placement of the relocated markers and/or the other markers in the perspective view in the mapping environment (e.g., using a polygonal resolution algorithm). The placement module 204 may place the marker adjacent to the physical location in the mapping environment identified through the address data.

The block interpolation module 206 may apply a block interpolation technique to generate the marker and/or to place the marker in the mapping environment adjacent to the physical location identified through the address data. The correction module 208 may correct the accuracy of the placement of the relocated marker in a particular perspective view.

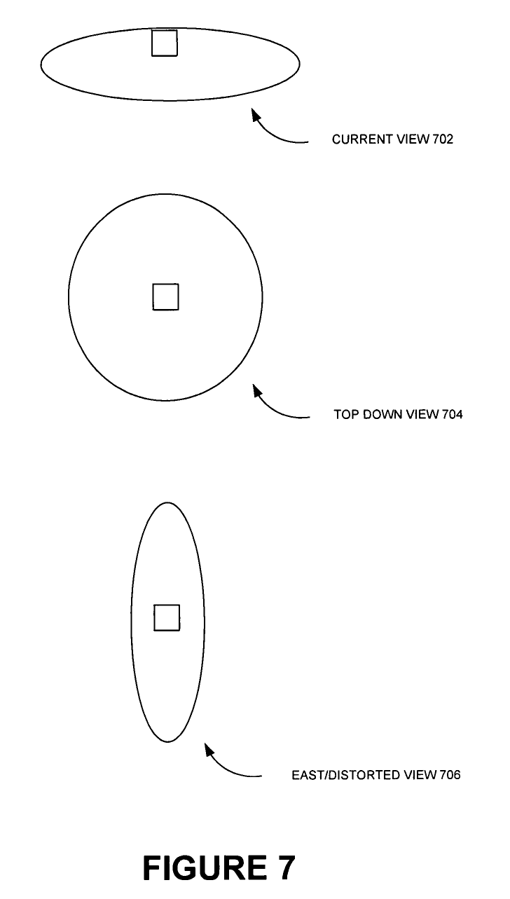

The zoom module 210 may enlarge and/or display greater detail of a portion of a geographic data set. The auto-generation module 212 may automatically relocate the marker to the center of the rooftop identified through the address data (e.g., responsive to the user-provided marker movement in the mapping environment). The view module 214 may generate the desired perspective view (e.g., the current view 702, the top down view 704 and/or the east/distorted view 706 illustrated in FIG. 7) of the relocated marker in the mapping environment.

The profile module 216 may enable the user to create a set of wiki profiles of the users in the neighborhood. In addition, the profile module 216 may process the profiles of the registered users and/or wiki profiles of the users associated with the physical location identified through the address data.

The location module 218 may capture (e.g., in the map) a graphical representation of locations physically present in the neighborhood through the set of markers indicating the profile (e.g., claimed profile, unclaimed profile) associated with the address data. The locking module 220 may process a marker locking request when the particular user claims the wiki profile associated with the address data. In addition, the locking module 220 may enable the user(s) to control the future relocation of the marker in the mapping environment. The selection module 222 may enable to select the physical location in the geospatial environment for physically relocating the pushpins to the desired location.

In the example embodiment illustrated in FIG. 2, the relocation module 102 may contain the rectification module 202, the placement module 204, the block interpolation module 206, the correction module 208, the zoom module 210, the auto generation module 212, the view module 214, the profile module 216, the location module 218, the locking module 220 and the selection module 222. The selection module 222 may communicate with the rectification module 202, the block interpolation module 206, the correction module 208, the auto generation module 212, the view module 214, and/or the profile module 216. The placement module 204 may communicate with the rectification module 202 and/or the block interpolation module 206. The zoom module 210 as illustrated in the FIG. 2 may communicate with the correction module 208 and/or the auto generating module 212. The location module 218 may communicate with the rectification module 202 and/or the profile module 216. The locking module 220 may communicate with the auto generating module 212 and/or the view module 214 according to the example embodiment illustrated in FIG. 2.

Furthermore, the marker in the mapping environment (e.g., the mapping environment 100 of FIG. 1) may be automatically relocated to the physical location identified through the address data responsive to the user-provided marker movement. The wiki marker movement request that identifies markers not claimed by any user may be generated in the mapping environment as candidates of relocation. In addition, a marker locking request may be processed when the wiki profile associated with the address data is claimed by the particular user. The particular user may be enabled to control future relocations of the marker when the user claims the wiki profile associated with the address data.

Moreover, the block interpolation technique in the algorithm may be applied to generate the marker and/or to place the marker in the mapping environment adjacent to the physical location identified through the address data. In addition, a dimensional perspective in the mapping environment may be applied while retaining the placement of the relocated marker and/or other markers in the mapping environment.

Furthermore, the accuracy of the placement of the relocated marker in the particular view may be corrected using a polygonal resolution algorithm through the rendering of the approximate polygonal shape that matches the distorted perspective in any view desired with the relocated marker through a vector and color matching methodology.

The mapping data which comprises the mapping environment may be refreshed while retaining the accuracy of placement of the relocated marker in the geo-spatial environment through the polygonal resolution algorithm and/or an error correction algorithm that compares refreshed map data with previous state map data to render geo-spatial distance coordination between marker points, using the latitudinal data and the longitudinal data.

The relocation module 102 may enable users of the geo-spatial environment to simultaneously move any one or more of the set of markers until the neighboring places and/or profiles are claimed by the claimants, so that more accurate location markers are enabled through the user-generated wiki edit of markers identified in the geo-spatial environment. The rectification module 202 may maintain any relocated marker in perspective view as accurately placed (e.g., based on the polygon and color matching algorithm that considers an effect of the distortion of the polygon underlying the marker when viewed in any particular perspective desired in the geo-spatial environment).

The locking module 220 may make subsequent movements of the relocated marker sequentially more difficult as a function of time, space, and/or verification of the location by other users in the geo-spatial environment when the other users choose to not move the relocated marker but do choose to move neighboring markers to the relocated marker in previous relocation events. In addition, the graphical representation of locations physically present in the neighborhood may be captured in the map through a set of pushpins each indicating the profile associated with the address. Also, any one or more of the set of pushpins may be physically relocated when the user drags and drops them to the desired location visible in the graphical representation. Furthermore, at least some pushpins in the map may be secured from movement by the user.

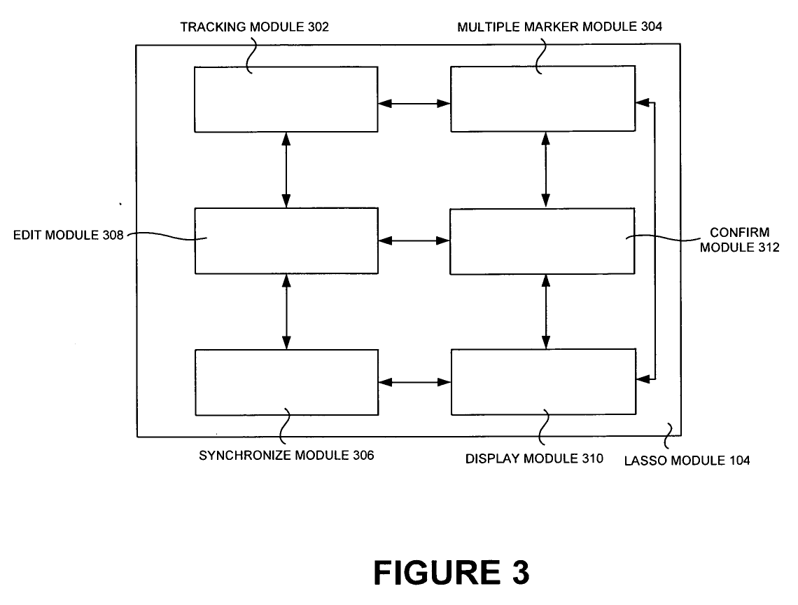

FIG. 3 is an exploded view of the lasso module 104 of FIG. 1, according to one embodiment. Particularly, FIG. 3 illustrates a tracking module 302, a multiple marker module 304, a synchronize module 306, an edit module 308, a display module 310, a confirm module 312, according to one embodiment.

The tracking module 302 may track the multiple markers that are to be group-moved. The multiple marker module 304 may enable the user to locate the set of markers representing the multiple profiles associated with the address data in the mapping environment. The synchronize module 306 may coordinate the multiple profiles associated with a same address data based on a level, (e.g., when the user drags and drops certain profiles associated with a segmented portion of the building). The edit module 308 may enable the user to edit the selected multiple profiles associated with the respective physical location identified through the address data.

The display module 310 may display tiered physical spaces in a building representing at least a subset of the neighboring places and/or profiles based on the physical separation between grouped profiles. The confirm module 312 may query the user in the geo-spatial environment to confirm the selection of multiple lassoed markers associated with the respective physical location.

In example embodiment illustrated in FIG. 3, the tracking module 302 communicates with the multiple marker module 304 and the synchronize module 306. The multiple marker module 304 communicates with the displaying module 310 and confirm module 312. The categorized module 306 communicates with the edit module 308 and the display module 310 as illustrated in example embodiment of FIG. 3.

Furthermore, multiple ones of the markers may be moved simultaneously when the marker edit state is transformed to the marker fixed state (e.g., based on the cached request of concurrent marker movements). Also, multiple ones of the adjacent properties in the neighborhood may be bulk relocated (e.g., responsive to the lassoing of multiple adjacent properties in the mapping environment). The lasso module 104 may enable selection of multiple markers simultaneously and group-moving of the lassoed markers simultaneously to a desired location.

Furthermore, a distinctive pushpin that represents multiple profiles may be created when there are multiple profiles associated with the same address. Some of profiles associated with the distinctive pushpin based on level may be organized when the user drags and drops certain of the profiles as being associated with the segmented portion of the building represented by the distinctive pushpin.

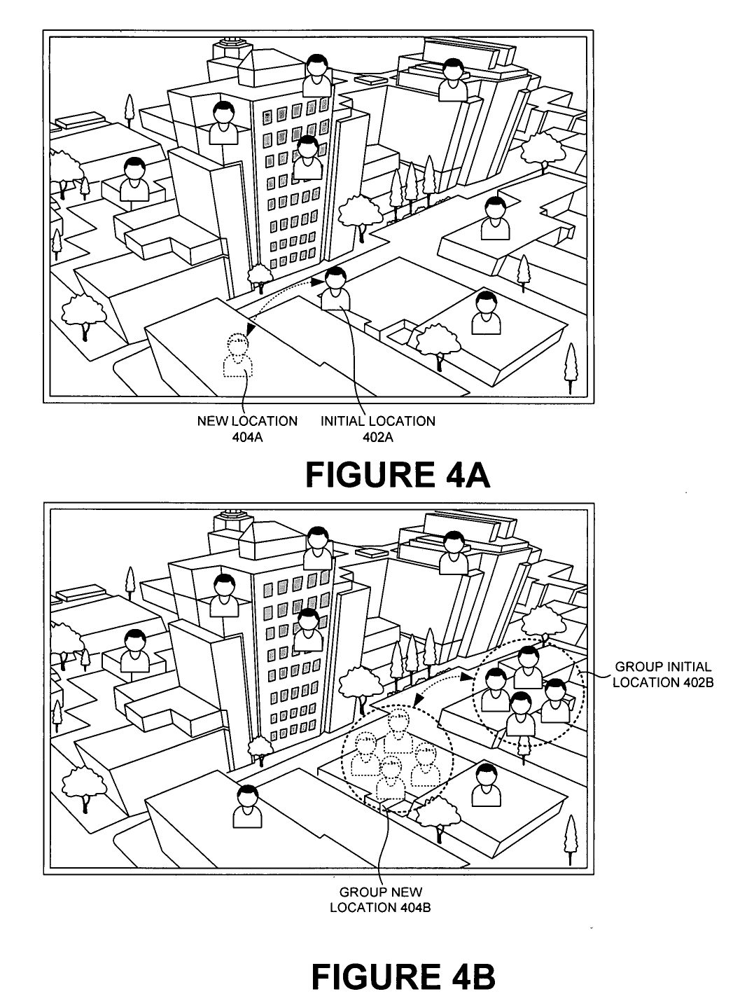

FIG. 4A is a map view showing the placement of a marker in the mapping environment, according to one embodiment. Particularly, FIG. 4A illustrates an initial location 402A and a new location 404A, according to one embodiment. The initial location 402A may be the location of the marker in the mapping environment provided by the user. The new location 404A may be the location of the marker accurately relocated at the physical location associated with the address data in the mapping environment. In the example embodiment illustrated in FIG. 4A, the map view may enable the user to locate a marker in the mapping environment adjacent to the physical location identified through the address data. The marker may be automatically relocated to the physical location based on the initial location 402A.

FIG. 4B is a map view showing placement of multiple markers in the mapping environment, according to one embodiment. Particularly, FIG. 4B illustrates a group initial location 402B and a group new location 404B, according to one embodiment. The group initial location 402A may be the location of the multiple markers associated with the multiple profiles in the mapping environment adjacent to the physical location identified through the address data provided by the user. The group new location 404B may be the location of the multiple markers accurately relocated at physical location associated with the multiple profiles in the mapping environment, in response to the user provided information. In the example embodiment illustrated in FIG. 4B, the map view may enable the user to relocate multiple markers in the mapping environment adjacent to the physical location identified through the address data. The set of markers may be automatically relocated to the physical location based on the group initial location 402B. Also, the multiple markers may be lassoed in the mapping environment to group-move the multiple markers to the desired physical location

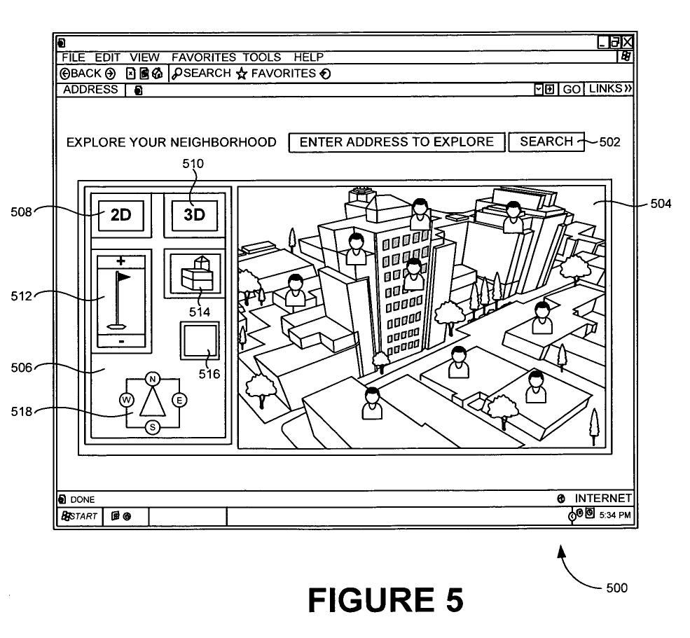

FIG. 5 is a user interface view 500 of locating markers in the mapping environment, according to one embodiment. Particularly, FIG. 5 illustrates a search option 502, a map view 504, a toolbar 506, a 2D option 508, a 3D option 510, a zoom control option 512, a map view generating option 514, a satellite view generating option 516, and a geographical direction indicator 518, according to one embodiment.

The search option 502 may enable the user to search and/or locate a physical location and/or profiles associated with an address data in the mapping environment. The map view 504 may enable the user to visualize (e.g., through a geospatial representation), the requested location and/or surrounding neighborhood. The toolbar 506 may enable the user to access different options in generating the geographical data in the mapping environment. The 2D option 508 may allow the user to visualize a two dimensional view of the physical location in the mapping environment. The 3D option 510 may enable the user in the neighborhood to generate a three dimensional view of the physical location in the mapping environment.

The zoom control option 512 may enable the user to zoom into and/or zoom out of a view of any location in the map to a desired scale. The map view generating option 514 may enable the user to generate multiple map views of the desired geographical location. The satellite view generating option 516 may generate a satellite view of the mapping environment. The geographical direction indicator option 518 may enable the user to generate navigation directions and/or distance estimations between the start position and the relocated marker position (e.g., based on the latitude and longitudinal data).

In the example embodiment illustrated in FIG. 5, the user interface view may enable the user to explore a neighborhood (e.g., the neighborhood 118A-N of FIG. 1) in a geo-spatial environment using the toolbar 506 consisting of the 2D option 508, the 3D option 510, the zoom control option 512, the map view generating option 514, the satellite view generating option 516, and the geographical direction indicator 518 to generate the map view 504 associated with the different geographical locations.

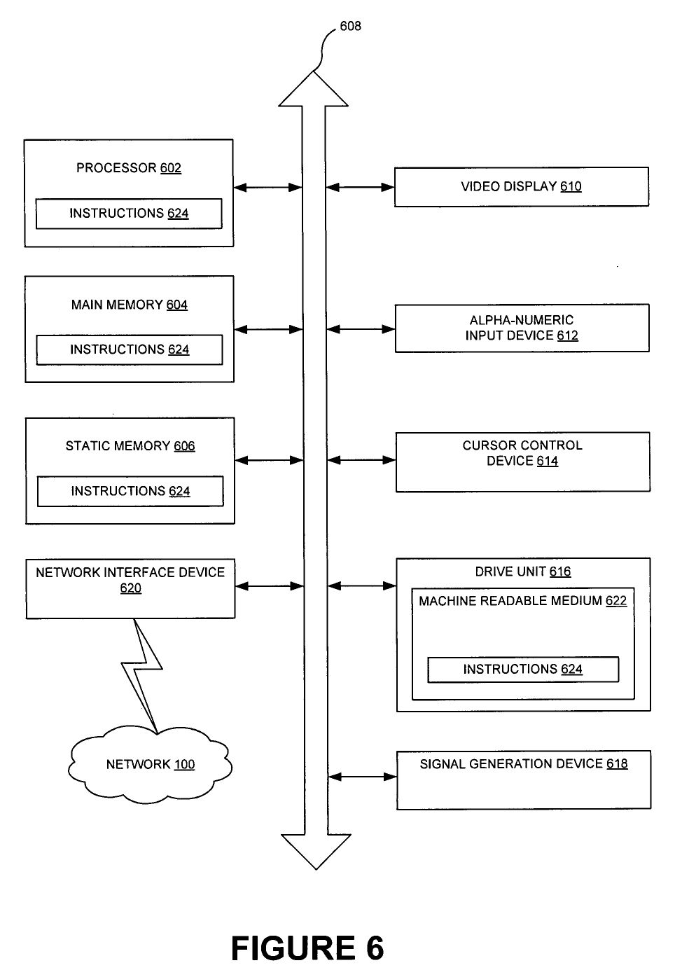

FIG. 6 is a diagrammatic system view 600 of a data processing system in which any of the embodiments disclosed herein may be performed, according to one embodiment. Particularly, the diagrammatic system view 600 of FIG. 6 illustrates a processor 602, a main memory 604, a static memory 606, a bus 608, a video display 610, an alpha-numeric input device 612, a cursor control device 614, a drive unit 616, a signal generation device 618, a network interface device 620, a machine readable medium 622, instructions 624, and a network 626, according to one embodiment.

The diagrammatic system view 600 may indicate a personal computer and/or a data processing system in which one or more operations disclosed herein are performed. The processor 602 may be microprocessor, a state machine, an application specific integrated circuit, a field programmable gate array, etc. (e.g., Intel® Pentium® processor). The main memory 604 may be a dynamic random access memory and/or a primary memory of a computer system.

The static memory 606 may be a hard drive, a flash drive, and/or other memory information associated with the data processing system. The bus 608 may be an interconnection between various circuits and/or structures of the data processing system. The video display 610 may provide graphical representation of information on the data processing system. The alpha-numeric input device 612 may be a keypad, keyboard and/or any other input device of text (e.g., a special device to aid the physically handicapped). The cursor control device 614 may be a pointing device such as a mouse.

The drive unit 616 may be a hard drive, a storage system, and/or other longer term storage subsystem. The signal generation device 618 may be a bios and/or a functional operating system of the data processing system. The network interface device 620 may be a device that may perform interface functions such as code conversion, protocol conversion and/or buffering required for communication to and from the network 626. The machine readable medium 622 may provide instructions on which any of the methods disclosed herein may be performed. The instructions 624 may provide source code and/or data code to the processor 602 to enable any one/or more operations disclosed herein.

FIG. 7 is a perspective view of markers arranged in the geospatial environment, according to one embodiment. Particularly, FIG. 7 illustrates a current view 702, a top down view 704 and an east/distorted view 706, according to one embodiment.

In example embodiment illustrated in FIG. 7, the current view 702 may be the view visualizing the marker placed on the polygon adjacent to the physical location identified through the address data. The top down view 704 may be a satellite view showing the marker placed on the polygon and/or may lock the polygon underlying the marker upon confirmation by the user in the neighborhood. The east/distorted view 706 may be a distorted view showing the replaced polygon underlying the relocated marker based on a polygon and color matching algorithm that may consider an effect of the distortion of the polygon underlying the marker.

Furthermore, the accuracy of the placement of the relocated marker in the particular view (e.g., the current view 702, the top down view 704 and/or the east/distorted view 706) may be corrected using a polygonal resolution algorithm through a rendering of the approximate polygonal shape that matches the distorted perspective in any view desired with the relocated marker (e.g., through a vector and color matching methodology).

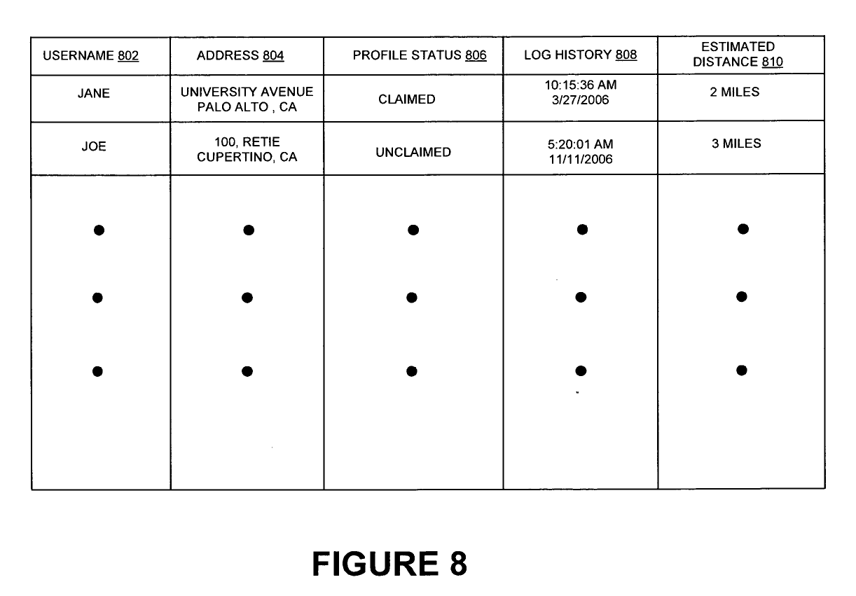

FIG. 8 is a table view showing marker data in a mapping environment, according to one embodiment. Particularly, FIG. 8 illustrates a username field 802, an address field 804, a profile status field 806, a log history field 808 and an estimated distance field 810, according to one embodiment.

The user name field 802 may display names of users in the neighborhood. The address field 804 may provide address data specified by the user to place the markers in the mapping environment at the physical location. The profile status field 806 may indicate whether the user has a claimed profile or an unclaimed profile. The log history field 808 may record a history of the marker relocations by the particular user in the neighborhood. The estimated distance field 810 may display information associated with the distance between initial position and relocated marker position.

In the hypothetical example illustrated in FIG. 8, the username field 802 displays “Jane” in first row and “Joe” in second row of the username field column 802. The address field 804 displays “University Avenue, Palo Alto, Calif.” in the first row and “100, Bette, Cupertino, Calif.” in the second row of the address field column 804. The profile status field 806 displays “claimed” in the first row and “unclaimed” in the second row of the profile status column 806. The log history 808 displays “10:15:36 AM, Mar. 27, 2006” in the first row and “5:20:01 AM, Nov. 11, 2006” in the second row of the log history column 808. The estimated distance 810 displays “2 miles” in the first row and “3 miles” in the second row of the estimated distance column 810.

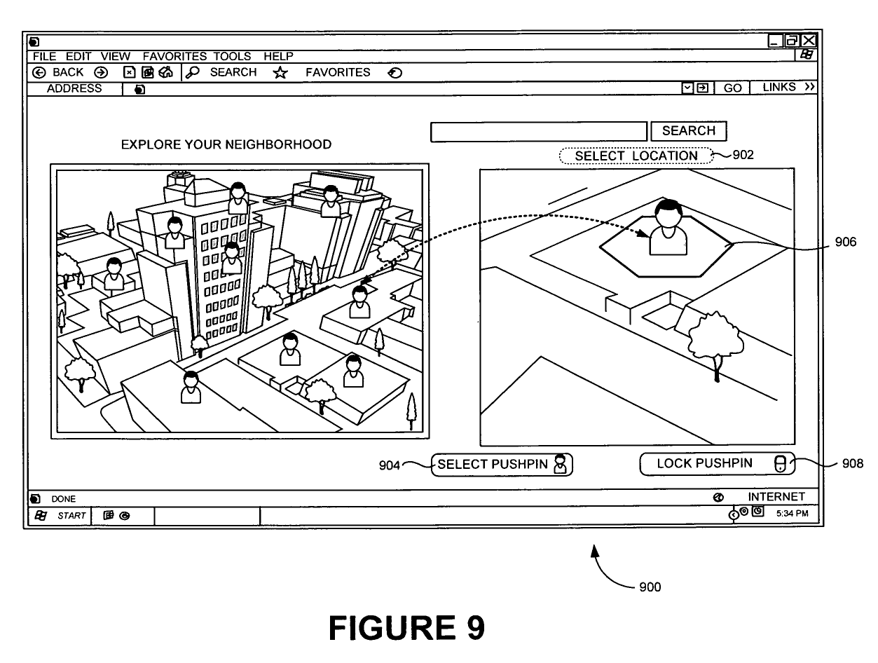

FIG. 9 is a user interface view of the relocation module 102 of FIG. 1, according to one embodiment. Particularly, FIG. 9 illustrates a select location option 902, a select pushpin option 904, a rooftop polygon 906, and a lock pushpin option 908, according to one embodiment.

The select location option 902 may enable the user to capture the graphical representation of the desired physical location associated with the address data in the geo-spatial environment. The select pushpin option 904 may enable the user to physically select and relocate a set of pushpins indicating the profile associated with the address data. The rooftop polygon 906 may enable the user to visualize the relocated pushpin in any perspective view of the mapping environment. The lock pushpin option 908 may enable the user to secure the pushpins from future relocations in the geo-spatial environment.

The example embodiment illustrated in FIG. 9, the user interface view may enable the user to locate the pushpin on the rooftop polygon 906 in the mapping environment through enabling the select location option 902 and/or may enable the user to lock pushpins from movement in the map (e.g., using the lock pushpin option 908).

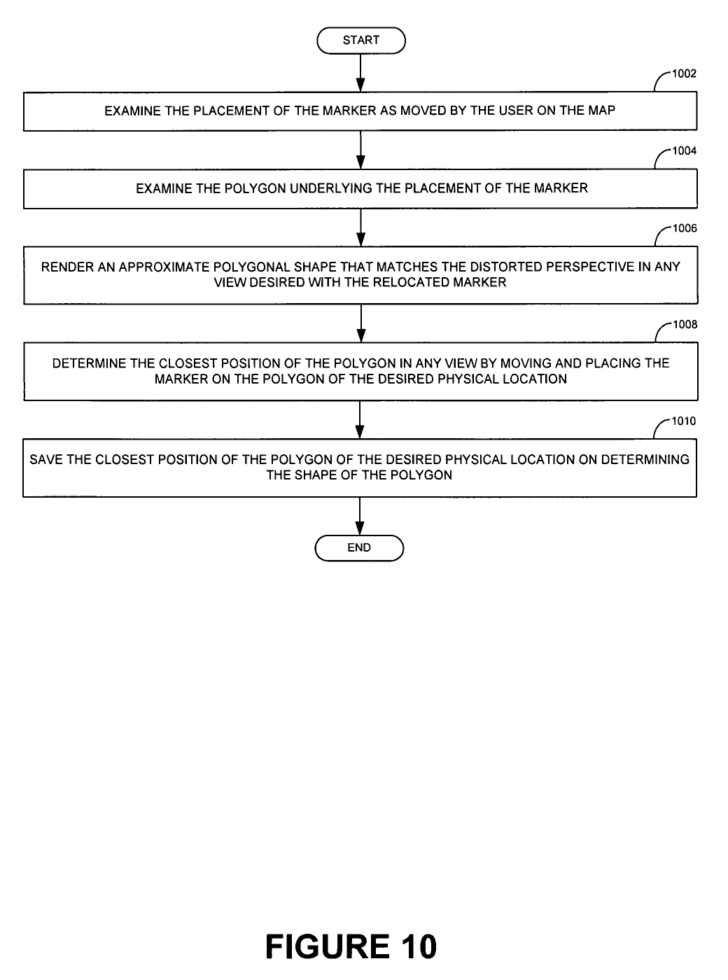

FIG. 10 is a flow chart of the polygon resolution algorithm, according to one embodiment. In operation 1002, the placement of the marker as moved by the user on the map is examined. In operation 1004, the polygon underlying the placement of the marker is examined. In operation 1006, an approximate polygonal shape that matches the distorted perspective in any view desired with the relocated marker is rendered. In operation 1008, the closest position of the polygon in any view is determined by moving and placing the marker on the polygon of the desired physical location. In operation 1010, the closest position of the polygon of the desired physical location is saved on determining the shape of the polygon.

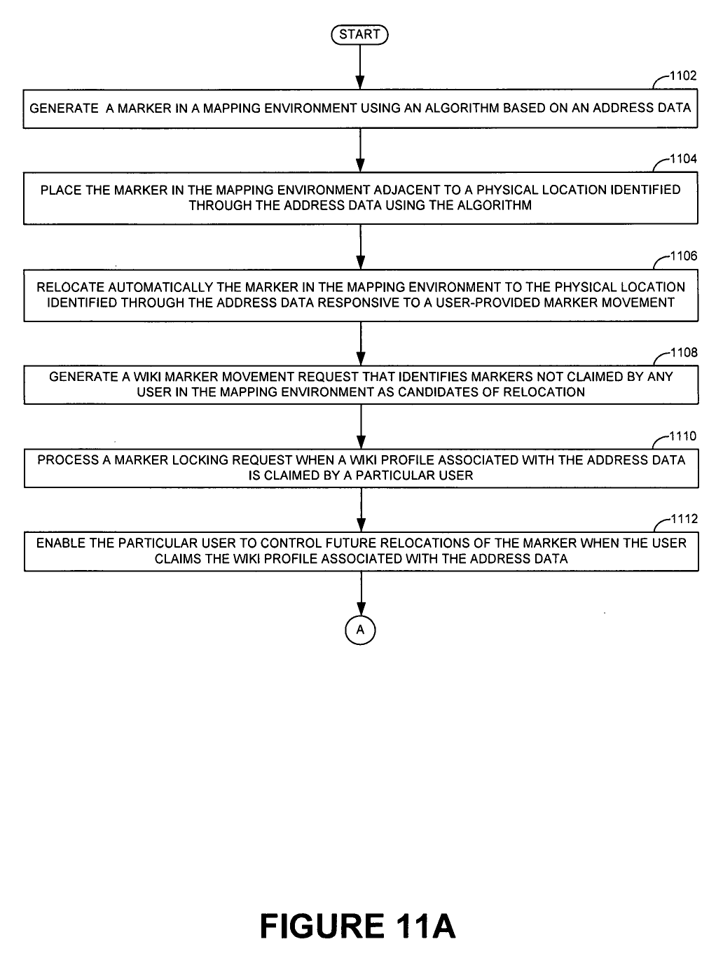

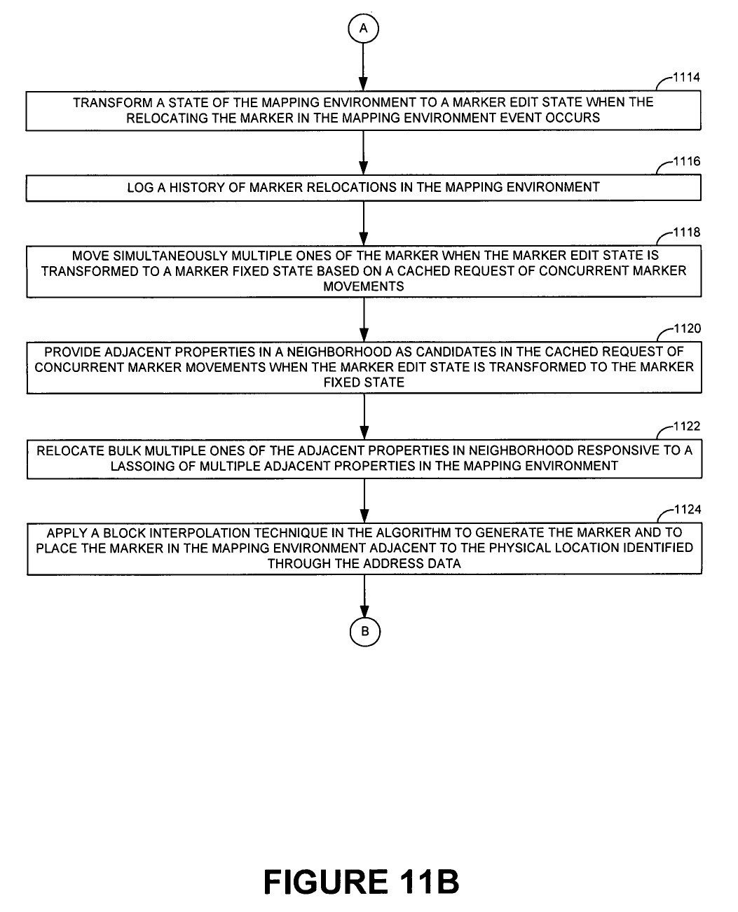

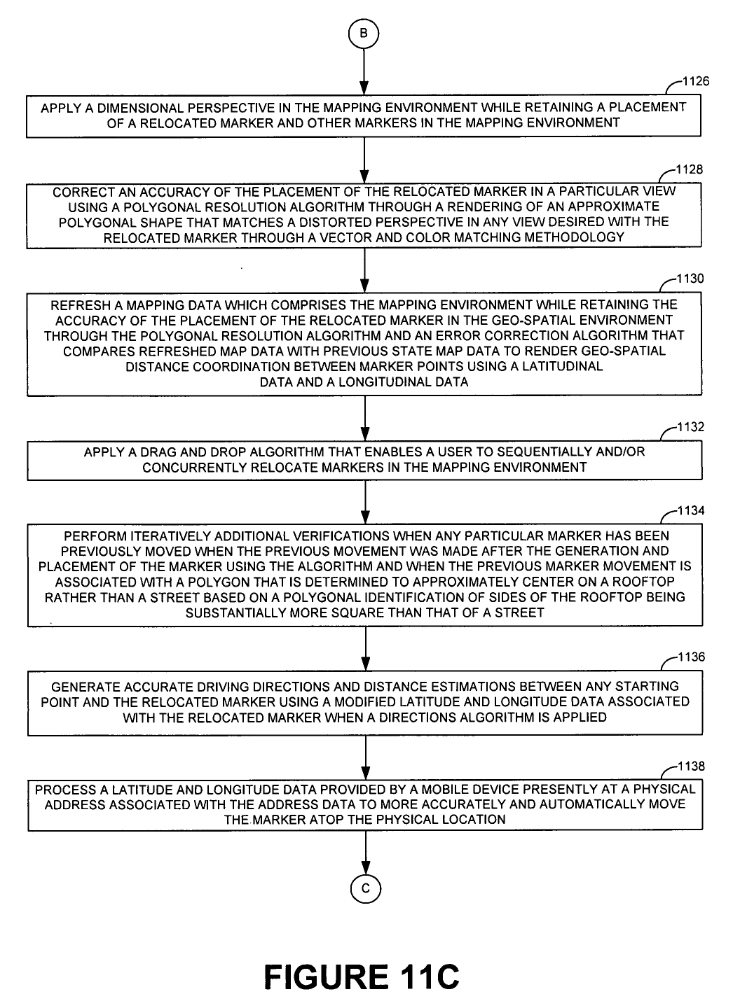

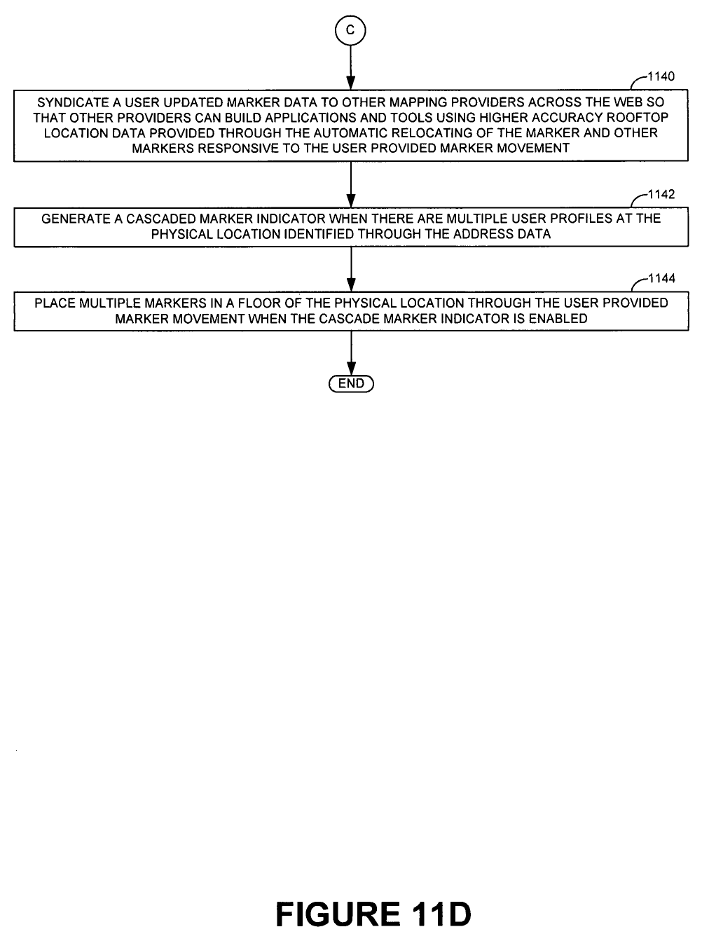

FIG. 11A is a process flow of relocating a marker in a mapping environment to a physical location identified through an address data, according to one embodiment. In operation 1102, a marker in the mapping environment (e.g., the mapping environment 100 of FIG. 1) may be generated using an algorithm based on the address data. In operation 1104, the marker in the mapping environment may be placed adjacent to the physical location identified through the address data using the algorithm. In operation 1106, the marker in the mapping environment may be automatically relocated (e.g., using the relocation module 102 of FIG. 1) to the physical location identified through the address data responsive to a user-provided marker movement.

In operation 1108, a wiki marker movement request that identifies markers not claimed by any user as candidates of relocation may be generated in the mapping environment. The operation 1110, a marker locking request may be processed when a wiki profile associated with the address data is claimed by a particular user. In operation 1112, the particular user may be enabled to control future relocations of the marker when the user claims the wiki profile associated with the address data.

FIG. 11B is a continuation of the process flow of FIG. 11A showing additional processes, according to one embodiment. In operation 1114, a state of the mapping environment may be transformed to a marker edit state when the relocating the marker in the mapping environment event occurs. In operation 1116, a history of marker relocations in the mapping environment may be logged. In operation 1118, multiple ones of the marker may be moved simultaneously when the marker edit state is transformed to a marker fixed state based on a cached request of concurrent marker movements.

In operation 1120, adjacent properties in a neighborhood (e.g., the neighborhood 118A-N of FIG. 1) may be provided as candidates in the cached request of concurrent marker movements when the marker edit state is transformed to the marker fixed state. In operation 1122, multiple ones of the adjacent properties in the neighborhood may be bulk relocated (e.g., using the lasso module 104 of FIG. 1-3) responsive to a lassoing of multiple adjacent properties in the mapping environment. In operation 1124, a block interpolation technique (e.g., generated using the block interpolation module 206 of FIG. 2) in the algorithm may be applied to generate the marker and/or to place the marker in the mapping environment adjacent to the physical location identified through the address data.

FIG. 11C is a continuation of the process flow of FIG. 11B showing additional processes, according to one embodiment. In operation 1126, a dimensional perspective in the mapping environment may be applied while retaining a placement of the relocated marker and/or other markers in the mapping environment. In operation 1128, an accuracy of a placement of the relocated marker in a particular view may be corrected using a polygonal resolution algorithm through a rendering of an approximate polygonal shape that matches a distorted perspective in any view desired with the relocated marker through a vector and color matching methodology.

In operation 1130, a mapping data which comprises the mapping environment may be refreshed while retaining the accuracy of the placement of the relocated marker in a geo-spatial environment through the polygonal resolution algorithm and an error correction algorithm that compares refreshed map data with previous state map data to render geo-spatial distance coordination between marker points using a latitudinal data and a longitudinal data.

In operation 1132, a drag and drop algorithm that enables the user to sequentially and/or concurrently relocate markers in the mapping environment may be applied. In operation 1134, additional verifications may be iteratively performed when any particular marker has been previously moved when the previous movement was made after the generation and placement of the marker using the algorithm and when the previous marker movement is associated with a polygon that is determined to approximately center on a rooftop rather than a street based on a polygonal identification of sides of the rooftop being substantially more square than that of the street.

In operation 1136, accurate driving directions and distance estimations between any starting point and the relocated marker may be generated using a modified latitude and longitude data associated with the relocated marker when a directions algorithm is applied. In operation 1138, a latitude and longitude data provided by a mobile device presently at a physical address associated with the address data may be processed to more accurately and automatically move the marker atop the physical location.

FIG. 11D is a continuation of the process flow of FIG. 11C showing additional processes, according to one embodiment. In operation 1140, a user updated marker data may be syndicated (e.g., through the syndication module 114 of FIG. 1) to other mapping providers across the web so that other providers can build applications and/or tools using higher accuracy rooftop location data provided through the automatic relocating of the marker and/or other markers responsive to the user provided marker movement. In operation 1142, a cascaded marker indicator may be generated when there are multiple user profiles at the physical location identified through the address data. In operation 1144, multiple markers may be placed in a floor of the physical location through the user provided marker movement when the cascade marker indicator is enabled.

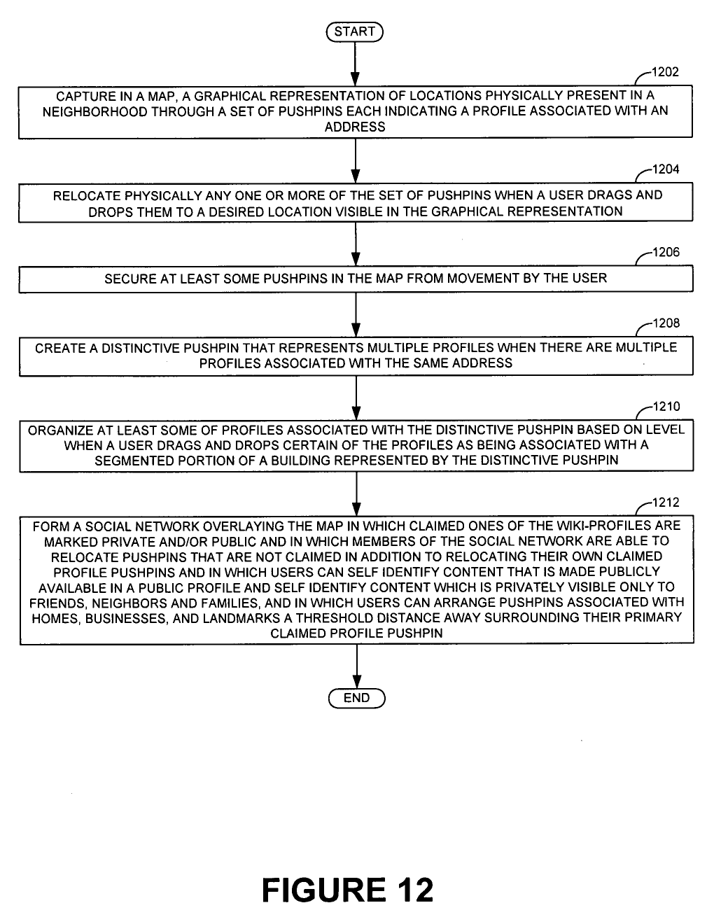

FIG. 12 is a process flow of locating a set of pushpins indicating profiles associated with an address data, according to one embodiment. In operation 1202, a graphical representation of locations physically present in a neighborhood may be captured in a map through the set of pushpins each indicating the profile associated with the address. In operation 1204, any one or more of the set of pushpins may be physically relocated when a user drags and drops (e.g., through a drag and drop module 110 of FIG. 1) them to a desired location visible in the graphical representation. In operation 1206, at least some pushpins in the map may be secured from movement by the user.

In operation 1208, a distinctive pushpin that represents multiple profiles may be created when there are multiple profiles associated with the same address. In operation 1210, some profiles associated with the distinctive pushpin may be organized based on level when the user drags and drops certain of the profiles as being associated with a segmented portion of a building represented by the distinctive pushpin.

In operation 1212, a social network overlaying the map may be formed in which claimed ones of the wiki-profiles are marked private and/or public and in which members of the social network are able to relocate pushpins that are not claimed in addition to relocating their own claimed profile pushpins and in which users can self identify content that is made publicly available in a public profile and/or self identify content which is privately visible only to friends, neighbors and/or families, and/or in which users can arrange pushpins associated with homes, businesses, and/or landmarks a threshold distance away surrounding their primary claimed profile pushpin.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal; Processor DSP circuitry).

For example the relocation module 102, the lasso module 104, the marker module 106, the floor plan module 108, the drag and drop module 110, the map module 112, the syndication module 114, the rectification module 202, the placement module 204, the block interpolation module 206, the correction module 208, the zoom module 210, the auto generation module 212, the view module 214, the profile module 216, the location module 218, the locking module 220, the selection module 222, the tracking module 302, the multiple marker module 304, the synchronize module 306, the edit module 308, the display module 310, the confirm module 312 and other modules of FIGS. 1-11 may be enabled using a relocation circuit, a lasso circuit, a marker circuit, a floor plan circuit, a drag and drop circuit, a map circuit, a syndication circuit, a rectification circuit, a placement circuit, a block interpolation circuit, a correction circuit, a zoom circuit, an auto generation circuit, a view circuit, a profile circuit, a location circuit, a locking circuit, a selection circuit, a tracking circuit, a multiple marker circuit, a synchronize circuit, an edit circuit, a display circuit, a confirm circuit and other circuits using one or more of the technologies described herein.

In addition, it will be appreciated that the various operations, processes, and methods disclosed herein may be embodied in a machine-readable medium and a machine accessible medium compatible with a data processing system (e.g., a computer system), and may be performed in any order. Accordingly, the specification and drawings are to be regarded in an illustrative rather than a restrictive sense.

What is claimed is:

1. A method comprising:
generating a marker in a mapping environment using an algorithm based on an address data;
placing the marker in the mapping environment adjacent to a physical location identified through the address data using the algorithm; and
automatically relocating the marker in the mapping environment to the physical location identified through the address data responsive to a user-provided marker movement.

2. The method of claim 1 further comprising:
generating a wiki marker movement request that identifies markers not claimed by any user in the mapping environment as candidates of relocation;
processing a marker locking request when a wiki profile associated with the address data is claimed by a particular user; and
enabling the particular user to control future relocations of the marker when the user claims the wiki profile associated with the address data.

3. The method of claim 2 further comprising:
transforming a state of the mapping environment to a marker edit state when the relocating the marker in the mapping environment event occurs;
logging a history of marker relocations in the mapping environment; and
simultaneously moving multiple ones of the markers when the marker edit state is transformed to a marker fixed state based on a cached request of concurrent marker movements.

4. The method of claim 3 further comprising providing adjacent properties in a neighborhood as candidates in the cached request of concurrent marker movements when the marker edit state is transformed to the marker fixed state.

5. The method of claim 4 further comprising bulk relocating multiple ones of the adjacent properties in neighborhood responsive to a lassoing of multiple adjacent properties in the mapping environment.

6. The method of claim 1 further comprising applying a block interpolation technique in the algorithm to generate the marker and to place the marker in the mapping environment adjacent to the physical location identified through the address data.

7. The method of claim 1 further comprising applying a dimensional perspective in the mapping environment while retaining a placement of a relocated marker and other markers in the mapping environment.

8. The method of claim 7 further comprising correcting an accuracy of the placement of the relocated marker in a particular view using a polygonal resolution algorithm through a rendering of an approximate polygonal shape that matches a distorted perspective in any view desired with the relocated marker through a vector and color matching methodology.

9. The method of claim 8 further comprising refreshing a mapping data which comprises the mapping environment while retaining the accuracy of the placement of the relocated marker in the geo-spatial environment through the polygonal resolution algorithm and an error correction algorithm that compares refreshed map data with previous state map data to render geo-spatial distance coordination between marker points using a latitudinal data and a longitudinal data.

10. The method of claim 1 further comprising:
applying a drag and drop algorithm that enables a user to at least one of sequentially and concurrently relocate markers in the mapping environment;
iteratively performing additional verifications when any particular marker has been previously moved when the previous movement was made after the generation and placement of the marker using the algorithm and when the previous marker movement is associated with a polygon that is determined to approximately center on a rooftop rather than a street based on a polygonal identification of sides of the rooftop being substantially more square than that of a street; and
generating accurate driving directions and distance estimations between any starting point and the relocated marker using a modified latitude and longitude data associated with the relocated marker when a directions algorithm is applied.

11. The method of claim 1 further comprising:
processing a latitude and longitude data provided by a mobile device presently at a physical address associated with the address data to more accurately and automatically move the marker atop the physical location;
syndicating a user updated marker data to other mapping providers across the web so that other providers can build applications and tools using higher accuracy rooftop location data provided through the automatic relocating of the marker and other markers responsive to the user provided marker movement;
generating a cascaded marker indicator when there are multiple user profiles at the physical location identified through the address data; and
placing multiple markers in a floor of the physical location through the user provided marker movement when the cascade marker indicator is enabled.

12. The method of claim 1 in a form of a machine-readable medium embodying a set of instructions that, when executed by a machine, causes the machine to perform the method of claim 1.

13. A system comprising:
a mapping module to render a geo-spatial environment concurrently representing neighboring places and profiles using a set of markers; and
relocation module to enable users of the geo-spatial environment to simultaneously move any one or more of the set of markers until the neighboring places and profiles are claimed by claimants, so that more accurate location markers are enabled through a user-generated wiki edit of markers identified in the geo-spatial environment.

14. The system of claim 13 further comprising a floor plan module to create tiered physical spaces in a building representing at least a subset of the neighboring places and profiles based on a physical separation between grouped profiles in at least one of a vertical, horizontal, and logical form such that the floor plan module segments and separates at least certain profiles in the geo-spatial environment from others and such that the floor plan module provides a context in which relocation of markers occurs in a fixed grouping of geo-spatially distributed floors.

15. The system of claim 14 further comprising a rectification module to maintain any relocated marker in perspective view as accurately placed based on a polygon and color matching algorithm that considers an effect of a distortion of a polygon underlying a marker when viewed in any particular perspective desired in the geo-spatial environment.

16. The system of claim 15 further comprising:
a lasso module to enable selection of multiple markers simultaneously and group-move the lassoed markers simultaneously to a desired location; and
a locking module to sequentially make more difficult subsequent movements of a relocated marker as a function of at least one of time, space, and verification of location by other users in the geo-spatial environment when the other users choose to not move the relocated marker but do choose to move neighboring markers to the relocated marker in previous relocation events.

17. A method comprising:
capturing, in a map, a graphical representation of locations physically present in a neighborhood through a set of pushpins each indicating a profile associated with an address;
physically relocating any one or more of the set of pushpins when a user drags and drops them to a desired location visible in the graphical representation; and
securing at least some pushpins in the map from movement by the user.

18. The method of claim 17 further comprising:
creating a distinctive pushpin that represents multiple profiles when there are multiple profiles associated with the same address; and
organizing at least some of profiles associated with the distinctive pushpin based on level when a user drags and drops certain of the profiles as being associated with a segmented portion of a building represented by the distinctive pushpin.

19. The method of claim 18 wherein the securing at least some pushpins is determined based on a claiming of a wiki-profile associated with the at least some pushpins by the user.

20. The method of claim 19 further comprising forming a social network overlaying the map in which claimed ones of the wiki-profiles are marked private and/or public and in which members of the social network are able to relocate pushpins that are not claimed in addition to relocating their own claimed profile pushpins and in which users can self identify content that is made publicly available in a public profile and self identify content which is privately visible only to friends, neighbors and families, and in which users can arrange pushpins associated with homes, businesses, and landmarks a threshold distance away surrounding their primary claimed profile pushpin.
